(19) United States
(12) Patent Application Publication
(10) Pub. No.: US 2021/0073581 A1
(43) Pub. Date: Mar. 11, 2021

(54) METHOD, APPARATUS AND COMPUTER PROGRAM FOR ACQUIRING A TRAINING SET OF IMAGES

(71) Applicant: CANON KABUSHIKI KAISHA, Tokyo (JP)

(72) Inventors: John MADSEN, Regstrup (DK); Louise ABELA, Kobenhavn S (DK)

(21) Appl. No.: 17/016,058

(22) Filed: Sep. 9, 2020

(30) Foreign Application Priority Data
Sep. 11, 2019 (GB) 1913111.9

(51) Int. Cl. G06K 9/62; H04N 7/18; H04N 5/235; G06K 9/00; G06K 9/20; H04N 5/76; G05D 1/02; G05B 13/02

(52) U.S. Cl. CPC G06K 9/6256; H04N 7/181; H04N 5/2352; G06K 9/00771; G05B 13/0265; G06K 9/209; H04N 5/76; G05D 1/0251; G06K 9/2027

(57) ABSTRACT

A method of acquiring a training set of images is carried out in an environment comprising at least one video surveillance camera, wherein the video camera is connected to a network including a video management server. The method comprises controlling a robot having an object attached to navigate to a plurality of locations, wherein each location is in the field of view of at least one camera. At each location, at least one camera which has the robot in its field of view is controlled to capture a plurality of images with different camera settings. Each image is stored with camera setting data defining the camera settings when the image was captured.

### CROSS-REFERENCE TO RELATED APPLICATIONS

This application claims the benefit under 35 U.S.C. § 119(a)-(d) of United Kingdom Patent Application No. 1913111.9, filed on Sep. 11th, 2019 and titled “A METHOD, APPARATUS AND COMPUTER PROGRAM FOR ACQUIRING A TRAINING SET OF IMAGES”. The above cited patent application is incorporated herein by reference in its entirety.

### BACKGROUND OF THE INVENTION

The present disclosure relates to a method, apparatus and computer program for acquiring a training set of images in an environment comprising at least one video surveillance camera, wherein the at least one video camera is connected to a network including a video management server.

A typical video surveillance camera suitable for use in an IP network including a video management server has several settings that the user can adjust to get the best image quality. For example, iris (or aperture), shutter speed or gain (or ISO) can be adjusted. However, what is best image quality depends on the situation and therefore it is necessary to choose settings accordingly. One use case is to find the optimal camera settings to get the best results from an object recognition program (e.g. YOLOv3). It would be desirable to develop a computer program that uses machine learning to do this automatically, but one issue with developing such a program is that it would require a very large dataset for training. The dataset will be images of objects captured using different camera settings, together with data on the camera settings used for each image and object recognition scores for each image for the object recognition program. This can be done manually but it requires days or maybe even weeks of work.

### SUMMARY OF THE INVENTION

The present disclosure provides a method which can automatically generate a training dataset of images that can be used to train software for optimising camera settings for an object recognition system (eg YOLOv3).

Since the present disclosure can be implemented in software, the present disclosure can be embodied as computer readable code for provision to a programmable apparatus on any suitable carrier medium. A tangible carrier medium may comprise a storage medium such as a hard disk drive, a magnetic tape device or a solid state memory device and the like.

### BRIEF DESCRIPTION OF THE DRAWINGS

Embodiments of the present disclosure will now be described, by way of example only, with reference to the accompanying drawings in which:

FIG. 1 illustrates an example of a video surveillance system;

FIG. 2 is a plan view of an environment in which the method of the present disclosure is carried out; and

FIG. 3 is a flow diagram of a method according to an embodiment of the present disclosure.

### DETAILED DESCRIPTION OF THE INVENTION

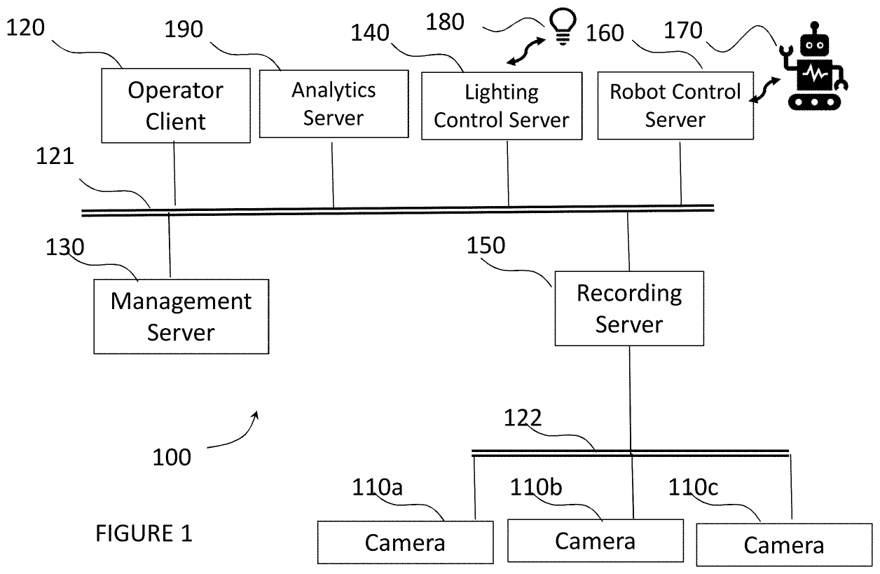

FIG. 1 shows an example of a video surveillance system 100 in which embodiments of the invention can be implemented. The system 100 comprises a management server 130, an analytics server 190, a recording server 150, a lighting control server 140 and a robot control server 160. Further servers may also be included, such as further recording servers, archive servers or further analytics servers. The servers may be physically separate or simply separate functions performed by a single physical server.

A plurality of video surveillance cameras 110a, 110b, 110c capture video data and send it to the recording server 150 as a plurality of video data streams. The recording server 150 stores the video data streams captured by the video cameras 110a, 110b, 110c.

An operator client 120 is a terminal which provides an interface via which an operator can view video data live from the cameras 110a, 110b, 110c, or recorded video data from the recording server 150. Video data is streamed from the recording server 150 to the operator client 120 depending on which live streams or recorded streams are selected by the operator.

The operator client 120 also provides an interface for the operator to control a lighting system 180 via a lighting server 140 and control a robot 170 via a robot control server 160. The robot control server 160 issues commands to the robot 170 via wireless communication.

The lighting control server 140 issues commands to the lighting system 180 via a wired or wireless network.

The operator client 120 also provides an interface via which the operator can control the cameras 110a, 110b, 110c. For example, a user can adjust camera settings such as iris (aperture), shutter speed and gain (ISO), and for some types of cameras, the orientation (eg pan tilt zoom settings).

The management server 130 includes management software for managing information regarding the configuration of the surveillance/monitoring system 100 such as conditions for alarms, details of attached peripheral devices (hardware), which data streams are recorded in which recording server, etc.. The management server 130 also manages user information such as operator permissions. When a new operator client 120 is connected to the system, or a user logs in, the management server 130 determines if the user is authorised to view video data. The management server 130 also initiates an initialisation or set-up procedure during which the management server 130 sends configuration data to the operator client 120. The configuration data defines the cameras in the system, and which recording server (if there are multiple recording servers) each camera is connected to. The operator client 120 then stores the configuration data in a cache. The configuration data comprises the information necessary for the operator client 120 to identify cameras and obtain data from cameras and/or recording servers.

The analytics server 190 runs analytics software for image analysis, for example motion or object detection, facial recognition, event detection. The analytics software can operate on live streamed data from the cameras 110a, 110b, 110c, or recorded data from the recording server 150. In the present embodiment, the analytics server 190 runs object recognition software.

Other servers may also be present in the system 100. For example, an archiving server (not illustrated) may be provided for archiving older data stored in the recording server 150 which does not need to be immediately accessible from the recording server 150, but which it is not desired to be deleted permanently. A fail-over recording server (not illustrated) may be provided in case a main recording server fails. A mobile server may decode video and encode it in another format or at a lower quality level for streaming to mobile client devices.

The operator client 120, lighting control server 140 and robot control server 160 are configured to communicate via a first network/bus 121 with the management server 130 and the recording server 150. The recording server 150 communicates with the cameras 110a, 110b, 110c via a second network/bus 122.

The robot 170, lighting system 180 and the cameras 110a, 110b, 110c can also be controlled by image acquisition software. The image acquisition software coordinates the movement of the robot 170, the settings of the lighting system 180, the capture of the images by the cameras 110a, 110b, 110c, and the application of object recognition to the captured images by object recognition software running on the analytics server 190, by communicating with the lighting control server 140, the robot control server 160, the cameras 110a, 110b, 110c and the analytics server 190.

The image acquisition software that controls the image capture process may run on the operator client 120. However, it could run on any device connected to the system, for example a mobile device connected via a mobile terminal, or on one of the other servers (eg the management server 130), or on another computing device different from the operator client 120, such as a laptop, that connects to the network.

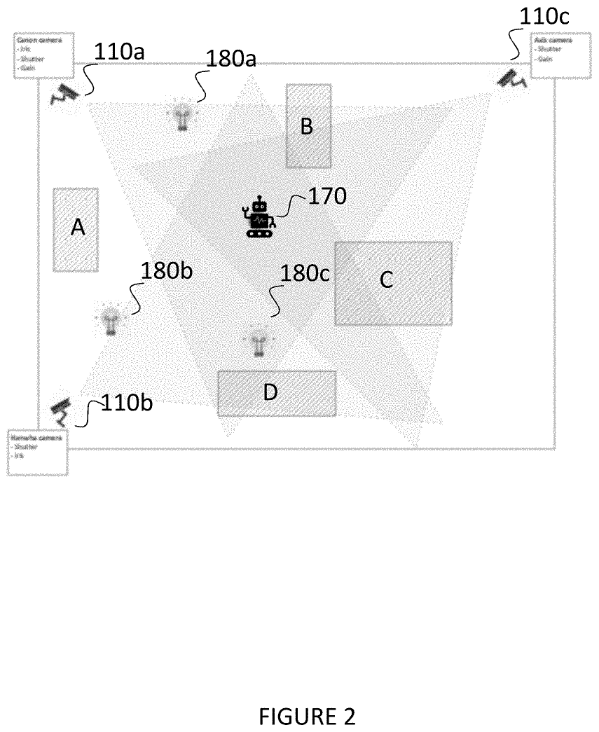

FIG. 2 is a plan view of an environment in which the method of the present disclosure is carried out. The environment includes the plurality of cameras 110a, 110b, 110c having different locations and fields of view which may overlap. The environment may be indoors such as an office building, shopping mall or multi storey car park, or it may be outdoors. The environment may also include a plurality of light sources 180a, 180b, 180b which are part of lighting system 180 and are controlled by lighting server 140. The environment also includes obstacles A, B, C and D, which may be fixed obstacles such as walls, or moveable obstacles such as parked cars or furniture.

The robot 170 can be controlled by wireless communication by the robot control server 160, and can navigate anywhere in the environment. There are a number of commercially available robots that could be used. In one embodiment, the robot is a TurtleBot2, controlled by a Jetson Xavier which is connected to the robot by USB cable and functions as a proxy between the robot control server 160 and the robot 170. In this example, the robot control server 160 sends commands to the Xavier box by Wifi (as the TurtleBot2 itself has no Wifi capability). On the Xavier box is installed a ROS (Robot Operating System) which allows control of the robot 170 by the robot control server 160. However, other configurations are possible and another robot may be used or developed which may have its own Wifi capability.

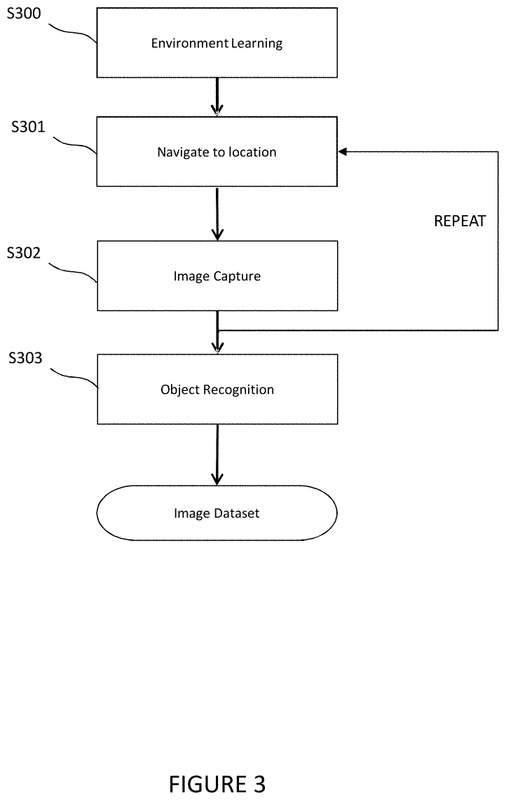

FIG. 3 is a flow diagram of a method of acquiring a training set of images in accordance with an embodiment of the invention. As an initial step S300, the robot 170 learns its environment to generate a map. The robot 170 travels around the environment building a grid, and for each element in the grid registers whether the robot 170 can go there or whether there is an obstacle in the way, and registers the exact position (so it can navigate there later). The robot itself includes sensors such as cliff edge detection and a bumper. It can also be determined which of the cameras can see the robot 170 from each position. This can be achieved using a simple Computer Vision algorithm, such as by putting an object of a specific colour on the robot 170, and applying a simple background subtraction. If the robot is decorated with a special colour that you otherwise will not find in the environment that it navigates, then it is relatively easy to determine whether the robot is within the field of view of a given camera. If more than a certain threshold number of pixels in a captured image are of (or very close to) the given colour, then the robot is within the field of view. Another option is to use a well know method of background subtraction. Several images from the camera without the robot are used to build a representation of the “background” (a background image). For any new images captured hereafter it can be determined whether the robot (or any other object for that matter) is in those images by simply subtracting them from the “background” image. If the robot is not in the image, this will result in a more or less black image. On the other hand, if the robot is in the image, it will stand out as a difference compared to the “background” image. The map, once generated, is supplied to the image acquisition software, and can be stored on whichever computing device the image acquisition software is running on, so that it can be accessed by the image acquisition software.

However, as an alternative to the environment learning step, the image acquisition software may already have a map of the environment including locations of cameras 110a, 110b, 110c, light sources 180a, 180b, 180c and obstacles A, B, C, D.

After the environment learning step, an object is associated with the robot 170. The object may be attached to the robot, or simply placed on a platform on top of the robot to enable to robot to carry the object. The object may be any object that can be recognised by object recognition software, such as a table or chair. Alternatively, if the environment is, for example, a car park, the object may be a vehicle license plate. It is also possible for the object to be a model that is not full scale, for example a model of a car. Object recognition software is often not scale sensitive, because it may not know how far away an object is in an image, so a model of a car may be recognised as a car.

Next, the acquiring of the images can start. In step S301, the image acquisition software instructs the robot control server 160 to instruct the robot 170 to navigate to a position where it is in the field of view of at least one camera. The robot control server 160 communicates with the robot 170 by wireless communication. The image acquisition software has access to the map and from this map, it can choose positions where it can send the robot 170 so that it is within the field of view of a particular camera. In this embodiment, the image acquisition software will handle one camera at a time, although if the robot 170 is in a position that is in the field of view of more than one camera then the image capture process could be carried out for multiple cameras at the same time. For a first camera, the image acquisition software will instruct the robot 170 to navigate to a location within its field of view.

When the robot reaches the location, it notifies the robot control server 160, and in step S302, the image acquisition software instructs the camera which can see the robot 170 to capture a plurality of images with different camera settings. At least one of iris (or aperture), shutter speed or gain (or ISO) can be varied, but as the image capture is controlled by software, a large number of images can be captured in a short period of time with different permutations of camera settings. The camera setting data is stored together with each image as metadata.

The image acquisition software can also instruct the lighting control server 140 to control the light sources 180a, 180b, 180c to vary the lighting conditions during the image acquisition, so that different images are acquired with different light settings (eg intensity and colour temperature). The light setting data is also stored with each image as metadata.

The robot control server 160 can also instruct the robot 170 to turn around so that the camera or cameras capture images at different angles. The robot may also be controllable to raise or tilt the object, or even move to a location where the object is partly obscured.

When image acquisition at the first location is completed, the robot 170 can be navigated to a second location (repeat step S301) and the image capture process (step S302) can be repeated. The image acquisition software will instruct the robot 170 to navigate to different positions, still within the field of view of the same camera, and then move on to a location within the field of view of a different camera. The process can then be repeated as many times as desired for different cameras and locations, and the dataset can be extended further by changing the object for a different object.

For each captured image, at step S303, the image acquisition software will control object recognition software running on the analytics server 190 to apply object recognition to the image to generate an object recognition score for each image. It is not necessary for this to happen whilst image acquisition is taking place, but if the object recognition is running as images are acquired, the object recognition scores can be used to determine when enough “good” data has been acquired to proceed to the next camera. If the object recognition is run as a final step after all of the images have been acquired, then the image acquisition software controls the robot 170 to navigate to a fixed number of positions within the field of view of each camera.

The order in which the parameters (camera settings and lighting settings) are varied is not essential, as long as the image acquisition software controls the cameras, the lighting and the robot to obtain a plurality of images with different camera settings, lighting settings and angles. As the whole process is controlled by the image acquisition software, it can be carried out very quickly and automatically without human intervention. Each image will have metadata associated with it indicating the settings (camera settings and lighting settings) when it was taken.

The images, when acquired, are stored in a folder on the operator client 120 or whichever computing device is running the image acquisition software.

For each acquired image, an object recognition system is applied and an object recognition score is obtained. As discussed above, this may be carried out in parallel with the image acquisition, or when image acquisition is complete. It could even be carried out completely separately. The images will be used to train software for optimising camera settings for a particular image recognition software (eg YOLOv3). The images are run through the particular image recognition software to obtain the object recognition scores, and then used to train the camera setting software.

In this way, a huge dataset of images can be acquired that can be used later for training a model for optimising the image quality with respect to the given object recognition system. The same dataset of images can be used for different object recognition systems, by carrying out the final step of obtaining the object recognition score by using the different object recognition system.

Further variations of the above embodiment are possible.

For example, not all environments will have lighting that is controllable via a network, so the lighting control server 140 and lighting system 180 is an optional feature. A large training dataset can still be acquired without controlling the lighting levels.

However, there are also other ways of obtaining images under different lighting conditions, for example by manually operating the lighting system, or by carrying out an image acquisition process at different times of day. The latter can be particularly useful in an outdoor environment.

It is described above that the image acquisition software that controls the image capture runs on the operator client 120. However, it could run on any device connected to the system, for example a mobile device connected via a mobile terminal, or on one of the other servers (eg the management server 130).

As described above, the object recognition is carried out at the same time as capturing the images, but this need not be the case. The images could be captured and stored together with camera setting data, and then used with different object recognition programs to obtain object recognitions scores, so that the same image dataset can be used to optimise camera settings for different object recognition programs.

While the present disclosure has been described with reference to embodiments, it is to be understood that the invention is not limited to the disclosed embodiments. The present disclosure can be implemented in various forms without departing from the principal features of the present disclosure as defined by the claims.

1. A method of acquiring a training set of images in an environment comprising at least one video surveillance camera, wherein the video camera is connected to a network including a video management server, the method comprising:
(1) controlling a robot including an object to navigate to a plurality of locations, wherein each location is in the field of view of at least one camera;
(2) at each location, controlling at least one camera which has the robot in its field of view to capture a plurality of images with different camera settings; and
(3) storing each image with camera setting data defining the camera settings when the image was captured.

2. The method according to claim 1, wherein the environment includes a plurality of video surveillance cameras, the plurality of locations are in the fields of view of different cameras.

3. The method according to claim 1, wherein the step of controlling the camera to acquire a plurality of images with different camera settings comprises changing at least one of shutter speed, iris (aperture) and gain (ISO).

4. The method according to claim 1, wherein the environment further includes at least one light source, and the method further includes, at each location, controlling the light sources and the camera to capture the plurality of images with different camera settings and different light source settings.

5. The method according to claim 4, wherein the step of controlling the light source comprises changing at least one of intensity and colour temperature.

6. The method according to claim 1, wherein the method comprises, at each location, controlling the robot to rotate, and acquiring images with the robot at different orientations.

7. The method according to claim 1, further comprising applying a computer implemented object recognition process to each acquired image to obtain a recognition score based on a degree of certainty with which the object attached to the robot is recognised, and storing each object recognition score with its corresponding image.

8. The method according to claim 1, wherein the method comprises the step of, before the acquisition of images, allowing the robot to learn the environment by moving around the environment and learning the locations of obstacles to generate a map of the environment.

9. The method according to claim 1, wherein the robot and the at least one camera are controlled by image acquisition software.

10. A non-transitory computer readable medium comprising computer readable instructions which, when run on a computer cause the computer to carry out a method of acquiring a training set of images in an environment comprising at least one video surveillance camera, wherein the video camera is connected to a network including a video management server, the method comprising:
(1) controlling a robot including an object to navigate to a plurality of locations, wherein each location is in the field of view of at least one camera;
(2) at each location, controlling at least one camera which has the robot in its field of view to capture a plurality of images with different camera settings; and
(3) storing each image with camera setting data defining the camera settings when the image was captured.

11. A video surveillance system comprising at least one video surveillance camera positioned at at least one location in an environment and connected to a network including a video management server, comprising control means configured to:
(1) control a robot including an object to navigate to a plurality of locations, wherein each location is in the field of view of at least one camera;
(2) at each location, control at least one camera which has the robot in its field of view to acquire a plurality of images with different camera settings; and
(3) store each image with camera setting data defining the camera settings when the image was captured.

12. The video surveillance system according to claim 11, comprising a plurality of video surveillance cameras positioned at different locations in the environment and connected to the network, wherein the robot is controlled to navigate to the plurality of locations which are in the fields of view of different cameras.

13. The video surveillance system according to claim 11, further including at least one light source in the environment and connected to the network, wherein the control means is further configured to:
at each location, control the light source and the camera to capture the plurality of images with different camera settings and different light source settings.

14. The video surveillance system according to claim 11, wherein the control means is further configured to:
at each location, control the robot to rotate, and control the camera to capture images with the robot at different orientations.

15. The video surveillance system according claim 11, further comprising means to apply a computer implemented object recognition process to each acquired image to obtain a recognition score based on a degree of certainty with which the object attached to the robot is recognised, and wherein the control means is further configured to store the object recognition score associated with each image.

16. The video surveillance system according to claim 11, wherein the control means comprises image acquisition software.

17. A method of creating a training model for making camera settings comprising using the images and the camera setting data therefor obtained by the method of claim 1.

18. A method according to claim 17, wherein the obtained images are subject to object recognition using a particular algorithm or technique and object recognition results therefrom are used to create the training model.
